(19) United States
(12) Patent Application Publication
(10) Pub. No.: US 2024/0177289 A1
(43) Pub. Date: May 30, 2024

(54) CONTROL METHOD AND APPARATUS, ELECTRONIC DEVICE AND STORAGE MEDIUM

(71) Applicant: Lenovo (Beijing) Limited, Beijing (CN)

(72) Inventors: Wei LIU, Beijing (CN); Jianxun WANG, Beijing (CN); Yonghua LIU, Beijing (CN)

(21) Appl. No.: 18/492,059

(22) Filed: Oct. 23, 2023

(30) Foreign Application Priority Data
Nov. 30, 2022 (CN) 202211530037.6

(51) Int. Cl. G06T 7/00; G06T 7/55; G06T 7/62; G06T 7/70; G06T 7/90

(52) U.S. Cl. CPC G06T 7/0004; G06T 7/55; G06T 7/62; G06T 7/70; G06T 7/90; G06T 2207/30108; G06T 2207/30168

(57) ABSTRACT

A control method includes: in response to receiving an image switching instruction, collecting images displayed on a display device at a second photographing frame rate to obtain a second resolution image sequence, the image switching instruction being used to instruct the display device to switch a displayed image; in response to a change of a target attribute of an image with a second resolution in the second resolution image sequence satisfying a condition, determining that the display device has completed switching of the displayed image; and collecting images displayed on the display device at a first photographing frame rate to obtain a first resolution image sequence, the first photographing frame rate being smaller than the second photographing frame rate, and the first resolution image sequence being used for defect detection of the display device.

### CROSS-REFERENCE TO RELATED APPLICATION

This application claims priority to Chinese Patent Application No. 202211530037.6, filed on Nov. 30, 2022, and the entire content of which is incorporated herein by reference.

### TECHNICAL FIELD

The present disclosure relates to the technical field of control technologies, and more particularly, to a control method and apparatus, an electronic device, and a storage medium.

### BACKGROUND

When detecting defects in a display device on a production line, the display device needs to be switched to display multiple test images. Each time the display device displays a test image, a camera collects an image of the display device. The multiple test images are automatically switched according to a certain time interval, and the camera collects images according to the above time interval. However, due to various uncertain factors, the camera may capture invalid images, such as the image of two test images being switched. The invalid images cannot be used to determine the quality of the display device. Therefore, how to prevent the camera from capturing the invalid images is a technical problem that needs to be solved.

### SUMMARY

One aspect of the present disclosure provides a control method. The control method includes: in response to receiving an image switching instruction, collecting images displayed on a display device at a second photographing frame rate to obtain a second resolution image sequence, the image switching instruction being used to instruct the display device to switch a displayed image; in response to a change of a target attribute of an image with a second resolution in the second resolution image sequence satisfying a condition, determining that the display device has completed switching of the displayed image; and collecting images displayed on the display device at a first photographing frame rate to obtain a first resolution image sequence, the first photographing frame rate being smaller than the second photographing frame rate, and the first resolution image sequence being used for defect detection of the display device.

Another aspect of the present disclosure provides a control apparatus. The control apparatus includes a memory storing a program and a processor couple to the memory. When being executed by the processor, the program causes the processor to: in response to receiving an image switching instruction, collect images displayed on a display device at a second photographing frame rate to obtain a second resolution image sequence, the image switching instruction being used to instruct the display device to switch a displayed image; in response to a change of a target attribute of an image with a second resolution in the second resolution image sequence satisfying a condition, determine that the display device has completed switching of the displayed image; and collect images displayed on the display device at a first photographing frame rate to obtain a first resolution image sequence, the first photographing frame rate being smaller than the second photographing frame rate, and the first resolution image sequence being used for defect detection of the display device.

Another aspect of the present disclosure provides a computer-readable storage medium storing a program. When being executed by a processor, the program causes the processor to: in response to receiving an image switching instruction, collect images displayed on a display device at a second photographing frame rate to obtain a second resolution image sequence, the image switching instruction being used to instruct the display device to switch a displayed image; in response to a change of a target attribute of an image with a second resolution in the second resolution image sequence satisfying a condition, determine that the display device has completed switching of the displayed image; and collect images displayed on the display device at a first photographing frame rate to obtain a first resolution image sequence, the first photographing frame rate being smaller than the second photographing frame rate, and the first resolution image sequence being used for defect detection of the display device.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIGS. 1A-1B are schematic views of two adjacent test images shown on a display device according to some embodiments of the present disclosure;

FIG. 1C is a schematic view of an invalid test image captured by a camera when the display device is switching from displaying the test image in FIG. 1A to displaying the test image in FIG. 1B according to some embodiments of the present disclosure;

FIGS. 1D-1E are schematic views of another two adjacent test images shown on the display device according to some embodiments of the present disclosure;

FIG. 1F is a schematic view of another invalid test image captured by the camera when the display device is switching from displaying the test image in FIG. 1D to displaying the test image in FIG. 1E according to some embodiments of the present disclosure;

FIG. 2 is a flowchart of an exemplary control method according to some embodiments of the present disclosure;

FIG. 3A is a schematic diagram showing a grayscale changing curve of an image with the second resolution image in a second resolution image sequence when the display device switches from displaying a smaller grayscale image to displaying a larger grayscale image according to some embodiments of the present disclosure;

FIG. 3B is a schematic diagram showing another grayscale changing curve of another image with the second resolution in another second resolution image sequence when the display device switches from displaying a large grayscale image to displaying a small grayscale image according to some embodiments of the present disclosure;

FIG. 4 is a flowchart of recognizing an object attached to the display device according to some embodiments of the present disclosure;

FIG. 5 is a schematic view of an exemplary test image including attached object recognition results according to some embodiments of the present disclosure;

FIGS. 6A-6C are schematic views of grayscale images collected by the image acquisition device and three exemplary attribute images of dust at three target positions when the display device displays three different test images according to some embodiments of the present disclosure;

FIG. 7 is a structural schematic diagram of an exemplary control apparatus according to some embodiments of the present disclosure; and

FIG. 8 is a structural schematic diagram of an exemplary electronic device according to some embodiments of the present disclosure.

### DETAILED DESCRIPTION OF THE EMBODIMENTS

In order to make the objectives, technical solutions, and advantages of the present disclosure clearer, the present disclosure will be further described in detail below with reference to the accompanying drawings. Obviously, the described embodiments are only some of the embodiments of the present disclosure, not all of the embodiments. Based on the embodiments of the present disclosure, all other embodiments obtained by those of ordinary skill in the art without creative efforts shall fall within the scope of the present disclosure.

The terms such as “first,” “second,” “third,” “fourth,” etc. (if present) in the description, claims and the drawings are used to distinguish similar parts and are not necessarily used to describe specific sequence or order. It is to be understood that data so used are interchangeable under appropriate circumstances such that the embodiments of the present disclosure described herein can be practiced in sequences other than illustrated herein.

The defect detection of display devices on the production line includes a “dead pixel detection” on the display device. Dead pixels on the display device may include but are not limited to: black dots, white dots, colored dots, light leakage, and frame offset, etc. In order not to miss any defect, the display device needs to display images in sequence. The images include black-and-white images (i.e., grayscale images) and color images. Each time an image is displayed, the displayed image is collected by an image acquisition device (e.g., a camera). The collected image is analyzed to determine whether the display device has dead pixels, that is, the quality of the display device is inspected based on the collected image.

Currently, in the process of the defect detection of the display device, the display device automatically switches according to a certain time interval, and the image acquisition device also collects images according to the same time interval. However, due to various uncertain factors, the image acquisition device may collect invalid images, for example, an image collected when the display device switches displaying two adjacent images.

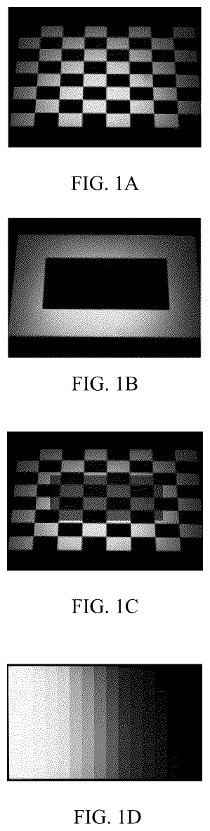

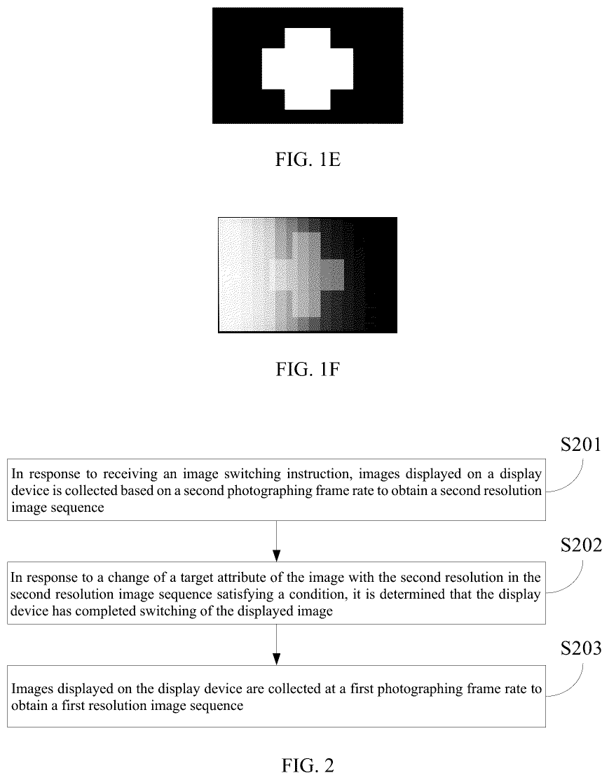

FIGS. 1A-1B are schematic views of two adjacent test images shown on a display device according to some embodiments of the present disclosure. After displaying one test image, the display device switches to displaying the other test image. While the image acquisition device is expected to collect the test images shown in FIGS. 1A-1B, the image acquisition device may collect the invalid image shown in FIG. 1C as well.

FIGS. 1D-1E are schematic views of another two adjacent test images shown on the display device according to some embodiments of the present disclosure. After displaying one test image, the display device switches to displaying the other test image. While the image acquisition device is expected to collect the test images shown in FIGS. 1D-1E, the image acquisition device may collect the invalid image shown in FIG. 1F as well.

To avoid collecting the invalid images, the present disclosure provides a control method and a control apparatus, that can be used in the image acquisition device.

FIG. 2 is a flowchart of an exemplary control method according to some embodiments of the present disclosure. As shown in FIG. 2, the method includes the following processes.

At S201, in response to receiving an image switching instruction, images displayed on a display device is collected based on a second photographing frame rate to obtain a second resolution image sequence. The image switching instruction is used to instruct the display device to switch a displayed image.

In some embodiments, the image switching instruction can be sent to an image acquisition device while the display device is triggered to switch the displayed image. In some other embodiments, the display device may be automatically triggered to switch the displayed image, and the display device can send an image switching instruction to the image acquisition device. In some other embodiments, the display device may be triggered to switch the displayed image by a third-party device that is neither the display device nor the image acquisition device, and the third-party device sends an image switching instruction to the image acquisition device.

Obtaining the image switching instruction refers to that the display device begins to switch the display image. At this time, the photographing frame rate of the image acquisition device is switched to the second photographing frame rate, such that the image acquisition device collects the image on the display device based on the second photographing frame rate to obtain a plurality of images with a second resolution, that is, a sequence of images with the second resolution. The sequence of images with the second resolution is used to determine whether the display device has completed switching of the displayed image.

In some embodiments, the second photographing frame rate is the maximum photographing frame rate that the image acquisition device can achieve. For example, the second photographing frame rate may be 35 fps (i.e., frames per second). If the maximum photographing frame rate that the image acquisition device can achieve is greater than 35 fps, then the second photographing frame rate can be 35 fps. The second photographing frame rate may be greater than 35 fps.

At S202, in response to a change of a target attribute of the image with the second resolution in the second resolution image sequence satisfying a condition, it is determined that the display device has completed switching of the displayed image.

The target attribute of the image with the second resolution may be the target attribute of the entire image with the second resolution, or may be the target attribute of a partial area of the image with the second resolution.

Each image with the second resolution in the second resolution image sequence is collected at different times. Therefore, the change of the target attribute of the image with the second resolution in the second resolution image sequence refers to the change of the target attribute of the image with the second resolution over time.

At S203, images displayed on the display device are collected at a first photographing frame rate to obtain a first resolution image sequence. The first photographing frame rate is smaller than the second photographing frame rate. The first resolution image sequence is used to conduct the defect detection of the display device.

When it is determined that the display device has completed switching of the displayed image, the photographing frame rate of the image acquisition device is switched to the first photographing frame rate. The image currently displayed by the display device is collected based on the first photographing frame rate to obtain the first resolution image sequence that can be used to conduct the defect detection of the display device.

Because the first photographing frame rate is smaller than the second photographing frame rate, the first resolution is larger than the second resolution, and the number of images in the second resolution image sequence is larger than the number of images in the first resolution image sequence.

In the control method provided by the embodiments of the present disclosure, if an image switching instruction is obtained, the image displayed on the display device is collected at a larger second photographing frame rate to obtain the second resolution image sequence. If the change of the target attribute of the image with the second resolution in the second resolution image sequence satisfies the condition, it is determined that the display device has completed switching of the displayed image. At this time, the smaller first photographing frame rate is used to collect the image displayed on the display device to obtain the first resolution image sequence for the defect detection of the display device. In other words, the image used for the defect detection of the display device is only collected after it is determined that the display device has completed switching of the displayed image on the display device, thereby avoiding collecting invalid images.

In some embodiments, the target attribute of the image with the second resolution may include at least one of the following: brightness or grayscale of the image with the second resolution.

The brightness or grayscale of objected attached to the display device in the image with the second resolution. In some embodiments, the objects attached to the display device may be dust or artificially attached objects, such as transparent films. For example, the transparent films may be applied at multiple positions randomly selected on the display device.

The image with the second resolution shows a shape of the object attached to the display device.

The image with the second resolution also shows an area of the object attached to the display device.

In some embodiments, the image acquisition device may be a color image acquisition device or a grayscale image acquisition device.

In some embodiments, the image acquisition device is the color image acquisition device, and the image collected by the image acquisition device is a color image. To determine the brightness of the image with the second resolution, a brightness of each pixel in the image with the second resolution is retrieved, and the brightness of all pixels in the image with the second resolution are averaged to obtain the brightness of the image with the second resolution. To determine the grayscale of the image with the second resolution, the image with the second resolution is converted into a grayscale image with the second resolution, and the grayscale of each pixel in the grayscale image with the second resolution is retrieved. The grayscales of all pixels are averaged to obtain the grayscale of the image with the second resolution.

In some embodiments, the image acquisition device is the color image acquisition device. To determine the brightness of the objects attached to the display device in the image with the second resolution, because there may be objects attached at multiple positions to the display device, the brightness of each pixel at the position of each of at least some of the objects attached to the display device is retrieved. The brightness of each pixel at the position of a same object attached to the display device is averaged to obtain the brightness of at least some of the objects attached to the display device in the image with the second resolution. To determine the grayscale of the objects attached to the display device in the image with the second resolution, the image with the second resolution is converted into the grayscale image with the second resolution, and the grayscale of each pixel at the position of each of at least some of the objects attached to the display device in the image with the second resolution is retrieved. The grayscale of each pixel at the position of a same object attached to the display device is averaged to obtain the grayscale of at least some of the objects attached to the display device in the image with the second resolution.

In some embodiments, the image acquisition device is the color image acquisition device. To determine the shape or area of the object attached to the display device in the image with the second resolution, the shape or area of each object at the position of at least some of the objects attached to the display device can be determined directly in the image with the second resolution. Alternatively, the image with the second resolution is first converted into the grayscale image with the second resolution, and the shape or area of each object at the position of at least some of the objects attached to the display device can then be determined in the grayscale image with the second resolution.

In some embodiments, the image acquisition device is the color image acquisition device. When the defect detection of the display device is conducted based on the first resolution image sequence, the image with the first resolution is first converted into the grayscale image with the first resolution, and the grayscale image with the first resolution image is used to conduct the defect detection of the display device.

In some embodiments, the image acquisition device is the grayscale image acquisition device, and the image collected by the image acquisition device is the grayscale image. In this case, the grayscale of each pixel in the image with the second resolution is retrieved, and the brightness of all pixels is averaged to obtain the grayscale of the image with the second resolution.

In some embodiments, the image acquisition device is the grayscale image acquisition device. Because multiple objects may be attached to the display device, the grayscale of each pixel at the position of each of at least some of the objects attached to the display device is retrieved in the image with the second resolution. The grayscale of each pixel at the position of a same object is averaged to obtain the grayscale of at least some of the objects attached to the display device in the image with the second resolution.

In some embodiments, the image acquisition device is the grayscale image acquisition device. Because multiple objects may be attached to the display device, to determine the shape or area of the objects attached to the display device in the image with the second resolution, the shape or area of each object at the position of at least some of the objects attached to the display device is determined in the image with the second resolution.

In some embodiments, the process of switching images displayed on the display device is a process in which one image gradually disappears and the next image gradually appears. In some embodiments, the condition that the change of the target attribute of the image with the second resolution in the second resolution image sequence satisfies may include: after the brightness of the image with the second resolution in the second resolution image sequence decreases, the brightness increases and remains in a stable state; or, after the grayscale of the image with the second resolution in the second resolution image sequence decreases, the grayscale increases and remains in a stable state.

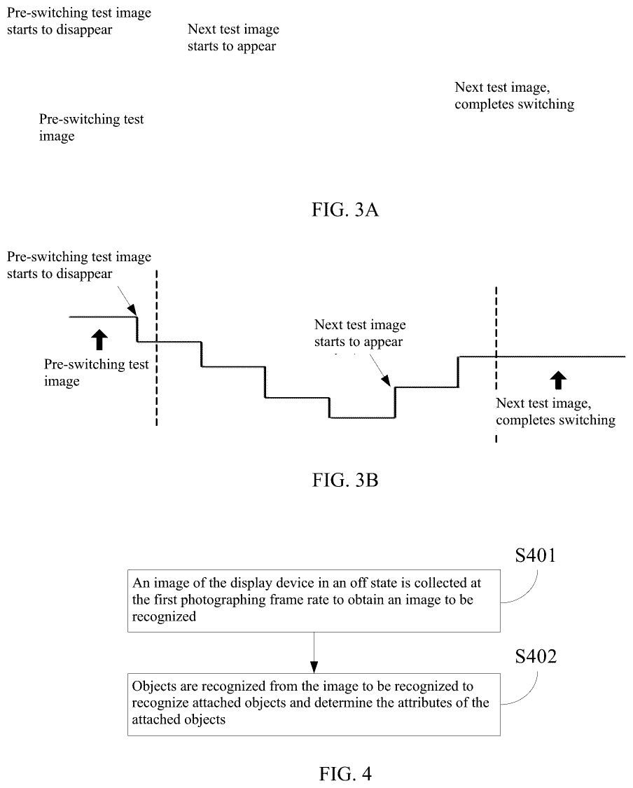

FIG. 3A is a schematic diagram showing a grayscale changing curve of an image with the second resolution in a second resolution image sequence when the display device switches from displaying a smaller grayscale image to displaying a larger grayscale image according to some embodiments of the present disclosure. As shown in FIG. 3A, the display device switches from a smaller grayscale image (that is, the test image before switching is a darker image) to a larger grayscale image (that is, the next test image is lighter image).

FIG. 3B is a schematic diagram showing another grayscale changing curve of another image with the second resolution in another second resolution image sequence when the display device switches from displaying a large grayscale image to displaying a small grayscale image according to some embodiments of the present disclosure. As shown in FIG. 3B, the display device switches from a larger grayscale image (i.e., a brighter image) to a smaller grayscale image (i.e., a darker image).

As shown in FIG. 3A and FIG. 3B, when the display device starts to switch images, the test image displayed on the display device will gradually disappear. At this time, the grayscale of the test image displayed on the display device gradually becomes smaller, and then begins to become larger after the grayscale drops to a certain value. It indicates that the next test image begins to appear. At this time, the grayscale of the test image displayed on the display device gradually becomes larger. When the grayscale reaches a certain value, it will remain stable for a short period of time, indicating that the test image displayed on the display device switches. After the switching is completed, the photographing frame rate of the image acquisition device is adjusted to the first photographing frame rate to collect test images for the defect detection of the display device.

In some embodiments, the change of the target attribute of the image with the second resolution in the second resolution image sequence satisfy the condition, which includes at least one of the following: after at least one of the brightness, the grayscale, or the area of the object attached to the display device in the image with the second resolution in the second resolution image sequence decreases, the at least one of the brightness, the grayscale, or the area of the object increases again in the stable state; after the shape of the object attached to the display device in the image with the second resolution in the second resolution image sequence disappears, another shape appears in the stable state.

As mentioned before, there may be multiple objects attached to the display device.

The brightness of the object attached to the display device in the image with the second resolution in the second resolution image sequence decreasing and then increasing to a stable state may include: the brightness of at least some of the objects attached to the display device in the image with the second resolution in the second resolution image sequence decreasing and then increasing to the stable state. The brightness of the object attached to the display device in the stable state may be the same as or different from the brightness of the at least some of the objects attached to the display device before the brightness decreases. Whether it is the same or not is determined by the images before and after switching.

The grayscale of the object attached to the display device in the image with the second resolution in the second resolution image sequence decreasing and then increasing to a stable state may include: the grayscale of at least some of the objects attached to the display device in the image with the second resolution in the second resolution image sequence decreasing and then increasing to the stable state. The grayscale of the object attached to the display device in the stable state may be the same as or different from the grayscale of the at least some of the objects attached to the display device before the grayscale decreases. Whether it is the same or not is determined by the images before and after switching.

The area of the object attached to the display device in the image with the second resolution in the second resolution image sequence decreasing and then increasing to a stable state may include: the area of at least some of the objects attached to the display device in the image with the second resolution in the second resolution image sequence decreasing and then increasing to the stable state. The area of the object attached to the display device in the stable state may be the same as or different from the area of the at least some of the objects attached to the display device before the grayscale decreases. Whether it is the same or not is determined by the images before and after switching. In some embodiments, the area of the object attached to the display device may be a pixel area occupied by the object, that is, a quantity of pixels in the area occupied by the object.

The shape of the object attached to the display device in the image with the second resolution in the second resolution image sequence disappearing and then appearing in a stable state may include: the shape of at least some of the objects attached to the display device in the image with the second resolution in the second resolution image sequence disappearing and then appearing in the stable state. The shape of the object attached to the display device in the stable state may be the same as or different from the shape of the at least some of the objects attached to the display device before the shape disappears. Whether it is the same or not is determined by the images before and after switching.

In some embodiments, the control method provided by the present disclosure further includes a process of recognizing an object attached to the display device. FIG. 4 is a flowchart of recognizing an object attached to the display device according to some embodiments of the present disclosure. As shown in FIG. 4, the method may include the following processes.

At S401, an image of the display device in an off state is collected at the first photographing frame rate to obtain an image to be recognized.

The display device in the off state refers to a state when the display device is not powered on. Because the display device is placed in a dark environment (such as a black box) when conducting the defect detection, it is impossible to photograph objects attached to the display device when the display device is turned off. To photograph the objects attached to the display device, a light source may be provided at a side of the display device to illuminate the side of the display device, such that the objects attached to the display device can be photographed.

Because the image to be recognized is collected at the first photographing frame rate, the resolution of the image to be recognized is the first resolution.

At S402, objects are recognized from the image to be recognized to recognize attached objects and determine the attributes of the attached objects. The attributes include at least one of position, shape, area, brightness, and grayscale.

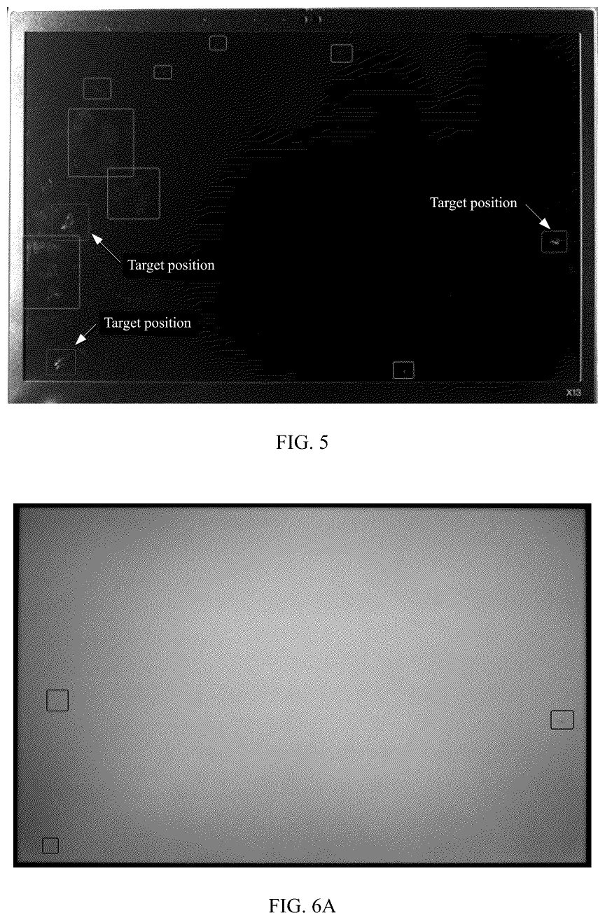

In some embodiments, a pre-trained attached object detection model may be used to process the image to be recognized to obtain an attached object recognition result. The attached object recognition result is used to indicate whether each pixel in the image to be recognized belongs to the attached object. The attached object recognition result may include but is not limited to: position information of the attached object. For example, the attached object recognition result may include positions of pixels belonging to the attached object, and position of an area of the attached object. The area of the attached object refers to an area where all the pixels belong to the attached object. The area of the attached object is often identified by a smallest enclosing rectangle. Therefore, the position of the area of the attached object can be the position of the enclosing rectangle of the area of the attached object. FIG. 5 is a schematic view of an exemplary test image including attached object recognition results according to some embodiments of the present disclosure. As shown in FIG. 5, the attached object is dust, and a total of 11 areas of dust are detected.

The shape, area, brightness, and grayscale of the attached object may be the shape, area, and brightness of the area of the attached object. The area of the attached object may be the pixel area of the attached object, that is, the number of pixels in the area of the attached object. The brightness or grayscale of the attached object is obtained by aggregating the brightness or grayscale of the pixels in the area of the attached object. For example, the brightness of the attached object is an average of the brightness of the pixels in the area of the attached object, and the grayscale of the attached object is an average of the grayscale of the pixels in the area of the attached object.

After obtaining the attribute of the area of each attached object in the image to be recognized (i.e., at least one of position, shape, area, brightness, or grayscale), the attached object at a target position may be recognized from the image to be recognized based on the attribute of the area of the attached object. The target position in the image with the second resolution in the second resolution image sequence is determined based on the target position in the image to be recognized. Then, the change of the target attribute of the attached object at the target position in the image with the second resolution is determined. As shown in FIG. 5, three dust positions are determined to be the target positions.

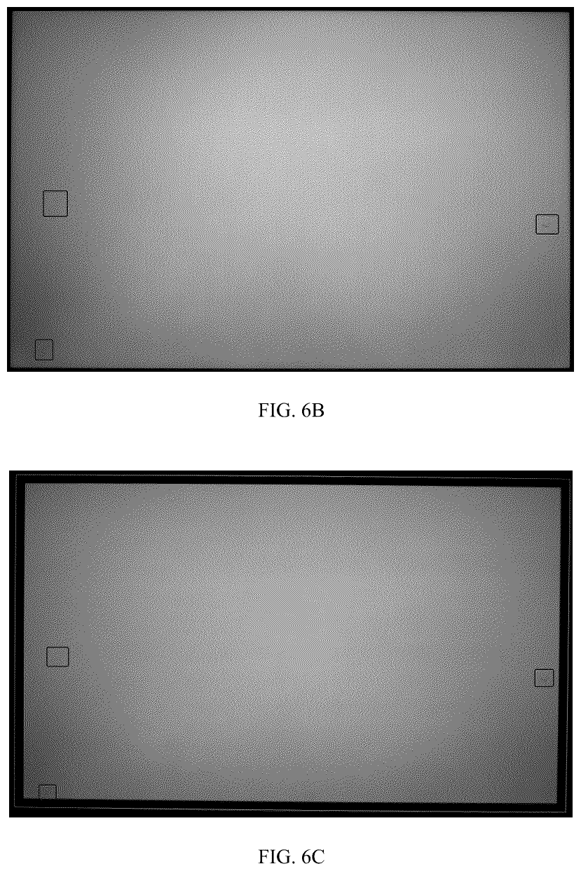

In some embodiments, the change of the target attribute of the attached object at the target position in the second resolution image sequence may be determined. The change of the target attribute of the attached object at the target position in the image with the second resolution is determined to be the change of the target attribute of the image with the second resolution in the second resolution image sequence. FIGS. 6A-6C are schematic views of grayscale images collected by the image acquisition device and three exemplary attribute images of dust at three target positions when the display device displays three different test images according to some embodiments of the present disclosure.

In some embodiments, a confidence level of an attached object at a target position is higher than a confidence level of an attached object at a non-target position. Some examples are described blow.

The shape of the attached object at the target position is an irregular shape. The shape of the attached object at the target position refers to a contour of the attached object at the target position. For example, the irregular shape may be a shape other than a rectangular, a circle, and an equilateral polygon.

The area of the attached object at the target position is greater than or equal to the area of the attached object at the non-target position.

The brightness of the attached object at the target position is greater than or equal to the brightness of the attached object at the non-target position.

The grayscale of the attached object at the target position is greater than or equal to the grayscale of the attached object at the non-target position.

In some embodiments, the position of the attached object in the image to be recognized is determined. After the second resolution image sequence is obtained, the position of the attached object in the image to be recognized, the first resolution, and the second resolution may be used to determine the position of the attached object in the image with the second resolution, such that the changes of the grayscale and brightness of the attached object can be accurately tracked. In some embodiments, the attached object recognized from the image with the second resolution may be the attached object recognized from the image to be recognized. Therefore, the attached object does not need to be recognized from the image with the second resolution.

In some other embodiments, the attached object recognized from the image with the second resolution may be different from the attached object recognized from the image to be recognized. As such, the method of recognizing the attached object from the image with the second resolution may include: after obtaining the second resolution image sequence, determining where the area of the attached object is in the image with the second resolution based on the position of the area of the attached object in the image to be recognized, the first resolution, and the second resolution; using the pre-trained attached object recognition model to recognize the attached object in the area of the attached object in the image with the second resolution to determine the position of each pixel of the attached object in the image with the second resolution; and determining the brightness, grayscale, shape, and area of the attached object in the image with the second resolution.

In some embodiments, there are multiple target positions. For example, 3-5 target positions can be provided. When the target attributes of the attached objects at the multiple target positions all remain stable, it is determined that the display device has completed switching of the displayed image.

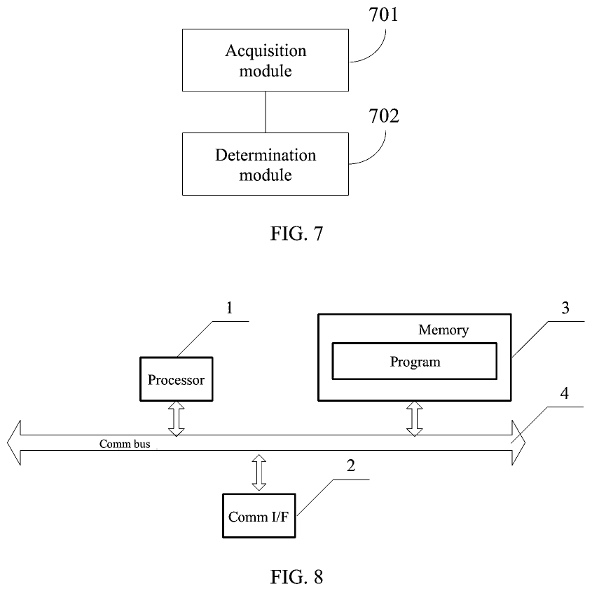

The present disclosure further provides a control apparatus to perform the processes of the control method. FIG. 7 is a structural schematic diagram of an exemplary control apparatus according to some embodiments of the present disclosure. As shown in FIG. 7, the control apparatus includes an acquisition module 701 and a determination module 702. The acquisition module 701 is configured to collect images displayed on the display device at the second photographing frame rate to obtain a second resolution image sequence in response to receiving an image switching instruction. The image switching instruction is used to instruct the display device to switch a displayed image. The determination module 702 is configured to determine that the display device has completed switching of displayed images if the change of the target attribute of the image with the second resolution in the second resolution image sequence satisfies a condition.

The acquisition module 701 is further configured to collect images currently displayed on the display device at a first photographing frame rate to obtain a first resolution image sequence. The first photographing frame rate is less than the second photographing frame rate. The first resolution image sequence is used for defect detection of the display device.

In some embodiments, the control apparatus collects images displayed on the display device at a higher second photographing frame rate to obtain a second resolution image sequence in response to receiving the image switching instruction. If the change of the target attribute in the image with the second resolution in the second resolution image sequence satisfies the condition, it is determined that the display device has completed switching of the displayed image. At this time, the images displayed on the display device are collected at the lower first photographing frame rate to obtain the image with the first resolution for the defect detection of the display device. In other words, the images for the defect detection of the display device are collected after the it is determined the display device has completed switching of the displayed image, thereby avoiding collecting invalid images.

In some embodiments, the target attribute includes at least one of the following: brightness or grayscale of the image with the second resolution, brightness or grayscale of the object attached to the display device, or the shape and area of the attached object.

In some embodiments, the condition that the change of the target attribute of the image with the second resolution in the second resolution image sequence satisfies includes: the brightness or grayscale of the image with the second resolution in the second resolution image sequence decreasing and then increasing to a stable state.

In some embodiments, the condition that the change of the target attribute of the image with the second resolution in the second resolution image sequence satisfies includes at least one of the following: at least one of the brightness, grayscale, and area of the attached object of the image with the second resolution in the second resolution image sequence decreasing and then increasing to a stable state; or the shape of the attached object disappearing in the image with the second resolution in the second resolution image sequence, and then appearing again in a stable shape.

In some embodiments, the collection module 701 is further configured to: acquire an image of the display device in an off state based on the first photographing frame rate to obtain an image to be recognized.

In some embodiments, the control apparatus further includes a recognition module configured to recognize the attached object from the image to be recognized to determine at least one of the position, shape, area, brightness, or grayscale of the recognized attached object.

In some embodiments, the determination module 702 is further configured to determine the change of the target attribute of the image with the second resolution in the second resolution image sequence based on the target attribute of the attached object recognized at the target position. The confidence level of the attached object at the target position is higher than the confidence level of the attached object at the non-target position.

In some embodiments, the confidence level of the attached object at the target position is higher than the confidence level of the attached object at the non-target position. For example, the shape of the attached object at the target position is an irregular shape. The area of the attached object at the target position is greater than or equal to the area of the attached object at the non-target position. The brightness of the attached object at the target position is greater than or equal to the brightness of the attached object at the non-target position. The grayscale of the attached object at the target position is greater than or equal to the grayscale of the attached object at the non-target position.

The present disclosure further provides an electronic device. The electronic device includes the control apparatus that performs the processes of the control method. FIG. 8 is a structural schematic diagram of an exemplary electronic device according to some embodiments of the present disclosure. As shown in FIG. 8, the electronic device includes at least one processor 1, at least one communication interface 2, at least one memory 3, and at least one communication bus 4.

In some embodiments, the number of the at least one processor 1, the at least one communication interface 2, the at least one memory 3, and the at least one communication bus 4 is at least one. The at least one processor 1, the at least one communication interface 2, and the at least one memory 3 communicate with each other through the at least one communication bus 4.

The at least one processor 1 may be a central processing unit (CPU), an application specific integrated circuit (ASIC), or one or more integrated circuits configured to implement the embodiments of the present disclosure.

The at least one memory 3 may include a high-speed RAM memory, and may also include a non-volatile memory, such as at least one disk memory.

The at least one memory 3 stores a program, and the at least one processor 1 may invoke the program stored in the at least one memory 3. The program is used for performing the following processes.

In response to receiving an image switching instruction, the images displayed on the display device are collected at a second photographing frame rate to obtain a second resolution image sequence. The image switching instruction is used to instruct the display device to switch a displayed image.

If the change of the target attribute of the image with the second resolution in the second resolution image sequence satisfies a condition, it is determined that the display device has completed switching of the displayed image.

The image currently displayed on the display device is collected at a first photographing frame rate to obtain a first resolution image sequence. The first photographing frame rate is smaller than the second photographing frame rate. The first resolution image sequence is used for the defect detection of the display device.

In some embodiments, for detailed functions and extended functions of the program, reference can be made to the previously described embodiments of the control method and control apparatus.

The present disclosure further provides a storage medium, which stores a program suitable for execution by a processor, where the program is used for performing the following processes.

In response to receiving an image switching instruction, the images displayed on the display device are collected at a second photographing frame rate to obtain a second resolution image sequence. The image switching instruction is used to instruct the display device to switch a displayed image.

If the change of the target attribute of the image with the second resolution in the second resolution image sequence satisfies a condition, it is determined that the display device has completed switching of the displayed image.

The image currently displayed on the display device is collected at a first photographing frame rate to obtain a first resolution image sequence. The first photographing frame rate is smaller than the second photographing frame rate. The first resolution image sequence is used for the defect detection of the display device.

In some embodiments, for detailed functions and extended functions of the program, reference can be made to the previously described embodiments of the control method and control apparatus.

Those of ordinary skill in the art will appreciate that the modules and algorithm steps of each example described in conjunction with the embodiments disclosed herein can be implemented with electronic hardware, or a combination of computer software and electronic hardware. Whether these functions are performed in hardware or software depends on specific applications and design constraints of the technical solution. Those skilled in the art may implement the described functionality using different methods for each specific application, but such implementations should not be considered beyond the scope of the present disclosure.

In the embodiments of the present disclosure, the disclosed systems, devices and methods can be implemented in other ways. On the other hand, the coupling or direct coupling or communication connection between each other shown or discussed may be through some interfaces. Indirect coupling or communication connection of the devices or modules may be electrical, mechanical, or in other forms.

The modules described as separate components may or may not be physically separated, and the components shown as modules may or may not be physical modules, that is, they may be in one place, or they may be distributed to multiple network units. Some or all the modules can be selected according to actual needs to achieve the purpose of the solution of the embodiments of the present disclosure.

In addition, each functional module in each embodiment of the present disclosure may be integrated into one processing unit. Each module may exist physically alone, or two or more modules may be integrated into one module.

In the embodiments of the present disclosure, the rights, various embodiments, and features can be combined with each other to solve the technical problems.

If the functions are implemented in the form of software functional units and sold or used as independent products, they can be stored in a computer-readable storage medium. Based on this understanding, the technical solution of the present disclosure or the part that contributes to the existing technology or the part of the technical solution can be embodied in the form of a software product. The computer software product is stored in a storage medium, including a plurality of instructions that can be used to cause a computer device (which may be a personal computer, a server, or a network device, etc.) to execute all or part of the steps of the methods described in various embodiments of the present disclosure. The storage media include: a U disk, a mobile hard disk, a read-only memory (ROM), a random-access memory (RAM), a magnetic disk or an optical disk, and other media that can store program code.

The above description of the disclosed embodiments is provided to enable any person skilled in the art to make or use the present application. Various modifications to these embodiments will be readily apparent to those skilled in the art, and the general principles defined herein may be implemented in other embodiments without departing from the spirit or scope of the present disclosure. Therefore, the present disclosure will not be limited to the embodiments shown herein but is to be accorded the broadest scope consistent with the principles and novel features disclosed herein.

What is claimed is:

1. A control method, comprising:
in response to receiving an image switching instruction, collecting images displayed on a display device at a second photographing frame rate to obtain a second resolution image sequence, the image switching instruction being used to instruct the display device to switch a displayed image;
in response to a change of a target attribute of an image with a second resolution in the second resolution image sequence satisfying a condition, determining that the display device has completed switching of the displayed image; and
collecting images displayed on the display device at a first photographing frame rate to obtain a first resolution image sequence, the first photographing frame rate being smaller than the second photographing frame rate, and the first resolution image sequence being used for defect detection of the display device.

2. The control method according to claim 1, wherein:
the target attribute includes at least one of brightness or grayscale of the image with the second resolution, brightness or grayscale of an object attached to the display device, a shape of the attached object, or an area of the attached object.

3. The control method according to claim 2, wherein the condition that the change of the target attribute of the image with the second resolution in the second resolution image sequence includes:
the brightness or grayscale of the image with the second resolution in the second resolution image sequence decreasing and then increasing to a stable state.

4. The control method according to claim 2, wherein the condition that the change of the target attribute of the image with the second resolution in the second resolution image sequence satisfies includes at least one of:
at least one of the brightness, the grayscale, the area of the attached object in the image with the second resolution in the second resolution image sequence decreasing and then increasing to a stable state; or
a shape of the attached object in the image with the second resolution in the second resolution image sequence disappearing and then appearing in a stable shape.

5. The control method according to claim 4, further comprising:
collecting an image of the display device in an off state at the first photographing frame rate to obtain an image to be recognized;
recognizing the attached object from the image to be recognized to determine at least one of a position, a shape, an area, brightness, or a grayscale of the recognized attached object; and
using the target attribute of the attached object recognized at a target position to determine the change of the target attribute of the image with the second resolution image in the second resolution image sequence;
wherein a confidence level of the attached object at a target position is higher than a confidence level of the attached object at a non-target position.

6. The control method according to claim 5, wherein the confidence level of the attached object at the target position being higher than the confidence level of the attached object at the non-target position includes at least one of:
the shape of the attached object at the target position being an irregular shape;
the area of the attached object at the target position being larger than or equal to the area of the attached object at the non-target position;
the brightness of the attached object at the target position being larger than or equal to the brightness of the attached object at the non-target position; or
the grayscale of the attached object at the target position being larger than or equal to the grayscale of the attached object at the non-target position.

7. A control apparatus, comprising:
a memory storing a program; and
a processor couple to the memory, when being executed by the processor, the program causing the processor to:
in response to receiving an image switching instruction, collect images displayed on a display device at a second photographing frame rate to obtain a second resolution image sequence, the image switching instruction being used to instruct the display device to switch a displayed image;
in response to a change of a target attribute of an image with a second resolution in the second resolution image sequence satisfying a condition, determine that the display device has completed switching of the displayed image; and
collect images displayed on the display device at a first photographing frame rate to obtain a first resolution image sequence, the first photographing frame rate being smaller than the second photographing frame rate, and the first resolution image sequence being used for defect detection of the display device.

8. The control apparatus according to claim 7, wherein:
the target attribute includes at least one of brightness or grayscale of the image with the second resolution, brightness or grayscale of an object attached to the display device, a shape of the attached object, or an area of the attached object.

9. The control apparatus according to claim 8, wherein the condition that the change of the target attribute of the image with the second resolution in the second resolution image sequence includes:
the brightness or grayscale of the image with the second resolution in the second resolution image sequence decreasing and then increasing to a stable state.

10. The control apparatus according to claim 8, wherein the condition that the change of the target attribute of the image with the second resolution in the second resolution image sequence satisfies includes at least one of:
at least one of the brightness, the grayscale, the area of the attached object in the image with the second resolution in the second resolution image sequence decreasing and then increasing to a stable state; or
a shape of the attached object in the image with the second resolution in the second resolution image sequence disappearing and then appearing in a stable shape.

11. The control apparatus according to claim 10, wherein the processor is further configured to:
collect an image of the display device in an off state at the first photographing frame rate to obtain an image to be recognized;
recognize the attached object from the image to be recognized to determine at least one of a position, a shape, an area, brightness, or a grayscale of the recognized attached object; and
use the target attribute of the attached object recognized at a target position to determine the change of the target attribute of the image with the second resolution image in the second resolution image sequence;
wherein a confidence level of the attached object at a target position is higher than a confidence level of the attached object at a non-target position.

12. The control apparatus according to claim 11, wherein the confidence level of the attached object at the target position being higher than the confidence level of the attached object at the non-target position includes at least one of:
the shape of the attached object at the target position being an irregular shape;
the area of the attached object at the target position being larger than or equal to the area of the attached object at the non-target position;
the brightness of the attached object at the target position being larger than or equal to the brightness of the attached object at the non-target position; or
the grayscale of the attached object at the target position being larger than or equal to the grayscale of the attached object at the non-target position.

13. A computer-readable storage medium storing a program, wherein when being executed by a processor, the program causes the processor to:
in response to receiving an image switching instruction, collect images displayed on a display device at a second photographing frame rate to obtain a second resolution image sequence, the image switching instruction being used to instruct the display device to switch a displayed image;
in response to a change of a target attribute of an image with a second resolution in the second resolution image sequence satisfying a condition, determine that the display device has completed switching of the displayed image; and
collect images displayed on the display device at a first photographing frame rate to obtain a first resolution image sequence, the first photographing frame rate being smaller than the second photographing frame rate, and the first resolution image sequence being used for defect detection of the display device.

14. The computer-readable storage medium according to claim 13, wherein:
the target attribute includes at least one of brightness or grayscale of the image with the second resolution, brightness or grayscale of an object attached to the display device, a shape of the attached object, or an area of the attached object.

15. The computer-readable storage medium according to claim 14, wherein the condition that the change of the target attribute of the image with the second resolution in the second resolution image sequence includes:
the brightness or grayscale of the image with the second resolution in the second resolution image sequence decreasing and then increasing to a stable state.

16. The computer-readable storage medium according to claim 14, wherein the condition that the change of the target attribute of the image with the second resolution in the second resolution image sequence satisfies includes at least one of:
at least one of the brightness, the grayscale, the area of the attached object in the image with the second resolution in the second resolution image sequence decreasing and then increasing to a stable state; or
a shape of the attached object in the image with the second resolution in the second resolution image sequence disappearing and then appearing in a stable shape.

17. The computer-readable storage medium according to claim 16, wherein the processor is further configured to:
collect an image of the display device in an off state at the first photographing frame rate to obtain an image to be recognized;
recognize the attached object from the image to be recognized to determine at least one of a position, a shape, an area, brightness, or a grayscale of the recognized attached object; and
use the target attribute of the attached object recognized at a target position to determine the change of the target attribute of the image with the second resolution image in the second resolution image sequence;
wherein a confidence level of the attached object at a target position is higher than a confidence level of the attached object at a non-target position.

18. The computer-readable storage medium according to claim 17, wherein the confidence level of the attached object at the target position being higher than the confidence level of the attached object at the non-target position includes at least one of:
the shape of the attached object at the target position being an irregular shape;
the area of the attached object at the target position being larger than or equal to the area of the attached object at the non-target position;
the brightness of the attached object at the target position being larger than or equal to the brightness of the attached object at the non-target position; or
the grayscale of the attached object at the target position being larger than or equal to the grayscale of the attached object at the non-target position.
